(19) United States
(12) Patent Application Publication
(10) Pub. No.: US 2005/0248870 A1
(43) Pub. Date: Nov. 10, 2005

(54) Magnetic tape reading system and method

(76) Inventors: Russell Ian Monk, Caldicot (GB); Robert Morling, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/119,515

(22) Filed: Apr. 29, 2005

(30) Foreign Application Priority Data
Apr. 30, 2004 (GB) 0409670.7

(51) Int. Cl. G11B 15/14; G11B 27/36

(52) U.S. Cl. 360/64; 360/31

(57) ABSTRACT

Methods and systems for reading data recorded on a magnetic storage medium are disclosed. One embodiment of the system includes a plurality of pickup elements and a controller. Each pickup element is arranged to have a respective read field for picking up a magnetic field from the magnetic storage medium, the read field being substantially adjacent to a read field of at least one other pickup element. Each pickup element is arranged to generate an output signal dependent on any magnetic field in its read field. The controller is arranged to select one of the output signals in dependence on at least one predetermined condition. Other systems and methods are also provided.

### CLAIM TO PRIORITY

This application claims priority to copending United Kingdom utility application entitled, “Magnetic Tape Reading System and Method,” having serial number GB 0409670.7, filed Apr. 30, 2004, which is entirely incorporated herein by reference.

### TECHNICAL FIELD

The present disclosure relates to a magnetic tape reading system and method.

### BACKGROUND

Magnetic tape is commonly used for storage of digital data. The digital data is accessed by a data transfer apparatus, which can perform one or both of storing (writing) data onto the tape, or accessing (reading) data previously stored on the tape. A generic term for a magnetic tape date transfer apparatus is a “tape drive.” A tape drive normally includes a tape head for one or both of reading and/or writing data from or to the magnetic tape. The tape head itself includes one or more tape head elements, which can perform one or both of these functions. One type of head used in tape drives is a rotary scan head (also known as a helical scan head). Typically, the head is in the form of a drum 10 that has one or more head elements 20 positioned on its cylindrical surface, as is shown in FIG. 1, for performing read and/or write operations. During a loading process of a tape cartridge holding tape for use by the tape drive, a portion of the tape 40 is deployed around the drum 10. During reading and/or writing, the tape 40 is moved in a direction A whilst the drum 10 rotates about an axis B. The drum 10 typically rotates much faster that the speed of movement of the tape 40 so that tracks 50 can be read from, or written to, the tape 40 by the head element(s) 20.

The or each head element 20 is a form of electromagnet (although head elements using other technologies such as magneto-resistivity are also possible). FIGS. 2a and 2b show examples of head elements in the form of electromagnets. Referring to FIG. 2a, the electromagnet 60 includes a number of windings 70 to which an electrical current is applied when writing, or through which it is detected when reading, and a gap 80. As a track 50 passes over the gap 80 during reading, the magnetic field of the recorded data fluctuates creating a magnetic flux in the electromagnet 60, which can be detected via the electrical current on the windings. A series of electrical signals produced in this manner can be turned into a data stream corresponding to the data on the track. The electromagnet 60 can be sandwiched between structural material 90, as is shown in FIGS. 2b and 3.

It is well known that operational problems may cause one or more tracks of information, recorded on magnetic tape storage media, to appear upon playback or reading as a distorted track.

One type of distorted track is a curved track. In this respect, problems such as those associated with the handling or guiding of a magnetic tape as it is being read may cause a track to appear as a curved track. If a track is severely curved, not all of the track will be passed over a head element during reading and this results in read errors.

Various schemes have been developed to handle reading of curved tracks. Some schemes primarily enable a track-reading head or transducer to follow the curvature of the track. Typically, this is done by mounting the track-reading head upon an element (such as a bi-morph leaf) that can be deflected to permit the head to follow the curved track. Such schemes generally require that the track be formatted at recording time to include not only the stored data information, but also a special tracking or servo signal, which must be continuously or periodically recorded along the length of the track. For example, U.S. Pat. No. 5,349,481, which is hereby incorporated by reference, discloses an apparatus and method that uses such a tracking signal in the form of bit-identifying information to determine if bits have been read that were expected. If the expected bits are not read the tape is rewound and re-read at a slower speed. During the re-reading operation, the read heads traverse modified azimuthal paths.

In addition to curved tracks, other types of distortion of the ideal track geometry may be present when a tape is read. Such distortion may be the result of the data write operation, the read operation, or both. Examples of such distortion include the following.
(a) Track pitch distortions caused during the recording process by fluctuating tape speed.

(b) Track angle variations caused by tape guide misalignment or by the use of tape having worn or damaged edges.

(c) Tape interchange between two data recorders having incompatible tape guide adjustments. This could result in combinations of track angle and track curvature problems during the data read process.

(d) Other types of distortion resulting from contaminants becoming deposited on the tape after the data were recorded. The presence of the contaminant could alter the way in which the read head follows the recorded track.

When a tape drive is attempting to read from a track, it needs to accurately position a head element over the recorded track in order to generate sufficient electrical signal from the magnetic field of the recorded data. It will be appreciated that this problem increases in magnitude as the track widths become smaller. Therefore, as tape drive technology attempts to fit more and more data onto a tape, the tracking accuracy required to generate adequate read signals is also increasing.

Thus, a heretofore unaddressed need exists in the industry to address the aforementioned deficiencies and inadequacies.

### SUMMARY

Embodiments of the present disclosure provide systems and methods for reading data recorded on a magnetic storage medium. Briefly described, in architecture, one embodiment of the system, among others, can be implemented as follows. The system includes a plurality of pickup elements and a controller. Each pickup element is arranged to have a respective read field for picking up a magnetic field from the magnetic storage medium. The read field is substantially adjacent to a read field of at least one other the pickup element. The pickup element is also arranged to generate an output signal dependent on any magnetic field in its read field, where the controller is arranged to select one of the output signals in dependence on at least one predetermined condition.

Embodiment of the present disclosure can also be viewed as providing methods for reading data recorded on a magnetic storage medium using a plurality of pickup elements. In this regard, one embodiment of such a method, among others, can be broadly summarized by the following steps: generating an output signal from each of a plurality of pickup elements in dependence on any magnetic field in its respective read field; and selecting an output signal from those output signals of the pickup elements in dependence on at least one predetermined condition. For this embodiment, each pickup element has a read field for picking up a magnetic field from the magnetic storage medium substantially adjacent to a read field of at least one other pickup element.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Embodiments of the present disclosure will now be described in detail by way of example only with reference to the accompanying drawings, in which:

FIG. 1 is a schematic diagram of part of an exemplary prior art tape drive including a rotary scan head;

FIGS. 2a and 2b are schematic diagrams of an exemplary prior art head elements suitable for use in the rotary scan head of FIG. 1;

FIG. 3 is a view of a portion of tape contacting face of the head element of FIG. 2b;

FIG. 4 is a schematic diagram of a rotary scan magnetic tape reading system according to one embodiment of the present disclosure;

FIG. 4a is a plan view showing selected elements of the system of FIG. 4;

FIG. 5 is a view of a portion of a head element having multiple pickup elements for use in the embodiment of FIG. 4; and,

FIGS. 6a and 6b are schematic diagrams illustrating the embodiment of FIG. 4 in operation;

FIG. 7 is a schematic diagram of a rotary scan magnetic tape reading system according to one embodiment of the present disclosure;

FIG. 8 is a view of a head element having multiple pickup elements for use in an embodiment of the present disclosure;

FIGS. 9a-9c are schematic diagrams illustrating the embodiment of FIG. 7 in operation;

FIG. 10 is a flow diagram of the steps of a method according to an embodiment of the present disclosure;

FIG. 11 is a schematic diagram of a tape reading system according to another embodiment of the present disclosure;

FIG. 12 is a schematic diagram of a linear magnetic tape reading system for use with another embodiment of the present disclosure; and,

FIG. 13 is a plan view illustrating an embodiment of the present disclosure in operation in a linear tape reading system.

### DETAILED DESCRIPTION

According to an aspect of the present disclosure, there is provided one embodiment of a system for reading data recorded on a magnetic storage medium including a plurality of pickup elements and a controller. Each pickup element is arranged to have a read field for picking up a magnetic field from the magnetic storage medium. The read field is substantially adjacent to a read field of at least one other pickup element. To generate an output signal dependent on any magnetic field in its read field, the controller is arranged to select an output signal from those of the pickup elements in dependence on one or more predetermined conditions.

Various embodiments of the present disclosure seek to provide embodiments of methods and systems in which multiple pickup elements are available to read a single track. In one embodiment, the pickup elements read fields that pickup magnetic fields within their respective read field. The pickup elements are arranged so that each read field is substantially adjacent to at least one other read field. In this manner, if a distorted track is encountered that meanders out of the read field of one pickup element, it should fall into the adjacent read field of another pickup element. The controller monitors the output signal from all pickup elements. The controller selects the best output signal from the pickup elements and if one of the other pickup elements subsequently presents a better output signal, then the controller switches to use the output signal from that element.

According to another aspect of the present disclosure, there is provided one embodiment of a method of reading data recorded on a magnetic storage medium including the step of generating an output signal from each of a plurality of pickup elements in dependence any magnetic field in its respective read field. Each pickup element has a read field for picking up a magnetic field from the magnetic storage medium substantially adjacent to a read field of at least one other pickup element. The method further includes the step of selecting an output signal from those of the pickup elements in dependence on one or more predetermined conditions.

According to another aspect of the present disclosure, there is provided an embodiment of a system for reading data recorded on a magnetic storage medium including a plurality of magnetic field reading means for detecting a magnetic field and generating an output signal in dependence on a detected magnetic field; and control means for selecting an output signal from one of the magnetic field reading means in dependence on predetermined criteria.

According to another aspect of the present invention, there is provided an embodiment of a system for reading data recorded on a magnetic storage medium including a plurality of pickup elements and a controller. Each pickup element is arranged to have a read field for picking up a magnetic field from the magnetic storage medium. The read field is substantially adjacent to a read field of at least one other pickup element. To generate an output signal dependent on any magnetic field in its read field, the controller is arranged to monitor the output signals over time and, for each point in time, to select an output signal from those of the pickup elements in dependence on one or more predetermined conditions including: output signal amplitude; signal-to-noise ratio; and an assessment based on a quality metric. According, to another aspect of the present disclosure, there is provided, in some embodiments, a helical scan head including the system as described above in relation to other aspects of the present disclosure.

Advantageously, embodiments of the present disclosure are able to read data from distorted tracks on a first pass without the need to reposition head elements or the tape. This enables tapes having distorted tracks, or otherwise, to be read effectively at a substantially full speed.

According to another aspect of the present disclosure, there is provided an embodiment of a system for reading data recorded on a storage medium including a plurality of pickup elements and a controller. Each pickup element is arranged to have a read field for detecting one or more predetermined characteristics from an area of the storage medium. The read field is substantially adjacent to a read field of at least one other pickup element. Each pickup element is further arranged to generate an output signal dependent on any predetermined characteristics in its read field. The controller is arranged to select an output signal from those of the pickup elements in dependence on one or more predetermined conditions.

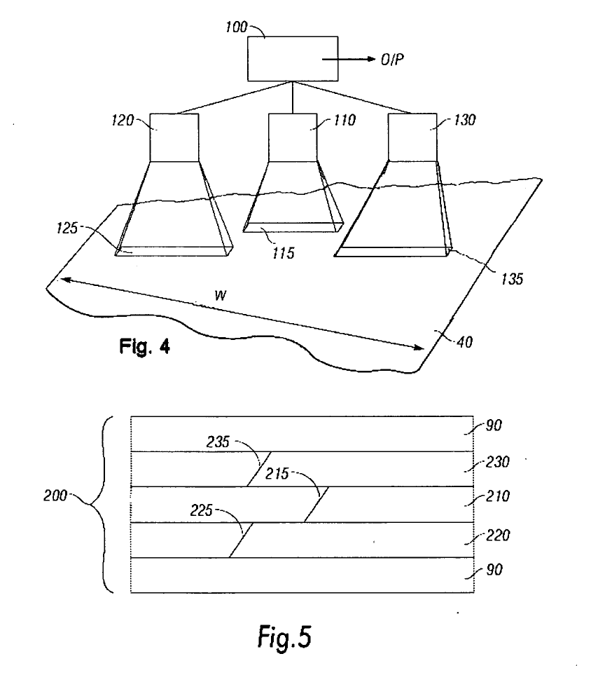

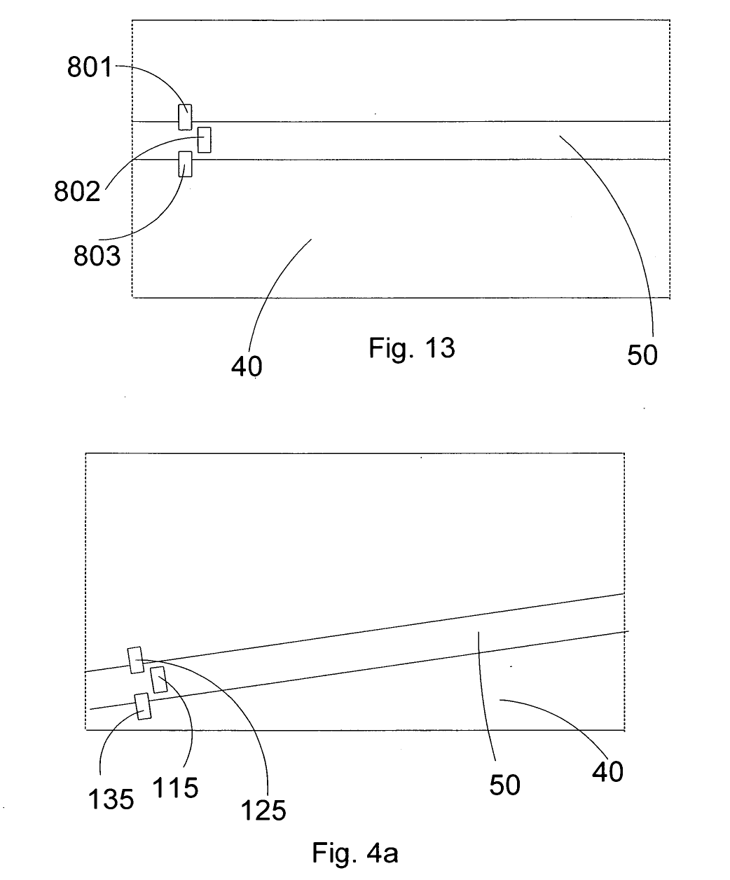

FIG. 4 is a schematic diagram of a rotary scan magnetic tape reading system according to one embodiment of the present disclosure. FIG. 4a is a plan view showing selected elements of the system of FIG. 4.

One embodiment of the tape reading system includes a controller 100 and a number of pickup elements 110, 120, 130. Each pickup element 110, 120, 130 is arranged to detect a magnetic field in its respective read field 115, 125, 135. For example, a pickup element will detect a magnetic field corresponding to a track on a magnetic tape 40, when the track passes through the respective read field. The pickup elements are arranged so that, in use, a path followed by each read field 115, 125, 135 is substantially adjacent the path at least one other read field. This relationship will be described in more detail below.

A first pickup element 110 is arranged to have a read field 115 following a path, when in use, that is disposed to coincide with the expected position of a track 50 to be read on the tape 40, and the second 120 and third 130 pickup elements are arranged to have read fields 125, 135 either side of the field 115 of the first pickup element 110 so that the paths followed by the read fields 125, 135, when in use, are substantially perpendicular to the expected orientation of the track.

Each pickup element 110, 120, 130 is arranged to communicate its output signal to the controller 100 which in turn is arranged, for each of a number of predetermined points in time, to select the output signal having the best signal and output this as a reading signal output signal (O/P). For the examples discussed herein, it is assumed that the predetermined points in time are selected so that the controller obtains an output for each data bit on a recording medium (the sampling period could be determined from the respective standard defining the magnetic data storage format). Alternatively, the controller may obtain more than one sample for each data bit and select the output based on the mean, median, or some other statistical or heuristic analysis. The “best” received output signal selected by the controller is determined in dependence on one or more predetermined conditions. These may include the signal magnitude (higher being better), lowest signal to noise ratio of the signals received, some other quality metric, or a combination of conditions, for example, combined in some form of weighted formula.

In this embodiment, read fields 125 and 135 are slightly offset in the direction of motion of the tape from read field 115 (which is expected to detect non-distorted tracks). This provides the controller time to switch the output signal from pickup element 110 to either of pickup elements 120 or 130. However, this is not essential and the pickup elements could be aligned so that their respective read fields are substantially adjacent at the same point in time. If the arrangement requires real time selection of an output signal and the controller is unable to achieve this, a buffer or some other form of memory may be provided in which the output signals from the pickup elements are stored to await processing by the controller.

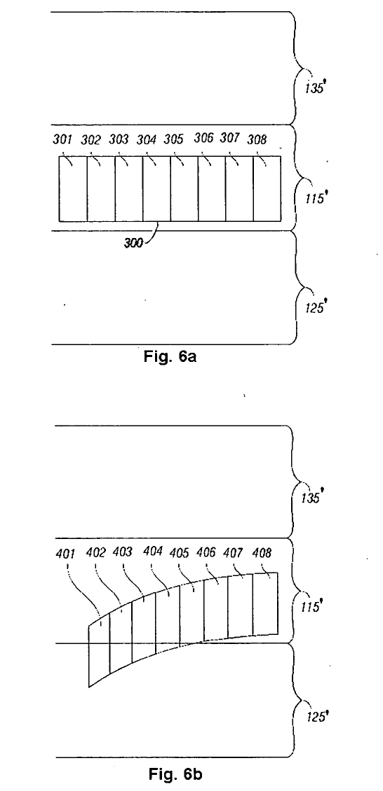

FIG. 5 is a view of a portion of a head element 200 having multiple pickup elements for use in the embodiment of FIG. 4. The view shows a portion of the tape contacting face of the head element 200. The head element 200 includes a first electromagnet 210, a second electromagnet 220, and a third electromagnet 230 sandwiched between structural material 90. Each electromagnet includes a gap 215, 225, 235, so as to be receptive to magnetic fields from tracks on tapes. The head element could be a ferrite or thin film or could be formed using any other materials/techniques available. FIGS. 6a and 6b are schematic diagrams illustrating the embodiment of FIG. 4 in operation.

As a track 300 passes through any of the respective read fields 115, 125, 135 of the pickup elements 110, 120, 130, an output signal is generated by the respective pickup element and presented to the controller 100. The paths followed by read fields 115, 125, 135 are labeled 115′, 125′ and 135′. In the case of a non-distorted track that is substantially correctly aligned, as is shown in FIG. 6a, the surface area of the track carrying each data bit 301-308 passes through the path 115′ followed by the read field 115 of the first pickup element 110 which generates corresponding output signals. As the track does not pass through the other read fields 125, 135, the pickup elements 120, 130 produce substantially no output signal and the controller 100 therefore, uses the output signal from the first pickup element 110 as the output signal from the reading system for each data bit 301-308.

In the case of a curved track 400, as is shown in FIG. 6b, the majority of the area of the track carrying the first data bit 401 falls within the path 125′ of the second read field 125. Based on the predetermined conditions, the controller 100 would therefore select the output signal from the second pickup element 120 for this data bit. However, by the second data bit 402, the majority of the area of the track falls within the path 115′ of the first read field 115, and the output signal from the first pickup element 110 would therefore be selected by the controller 100 in respect of the data bit 402. Similarly, for data bits 403-408, the majority of the track falls within the path 115′ of the first read field 115, so, the controller would continue to select the output from the first pickup element 110.

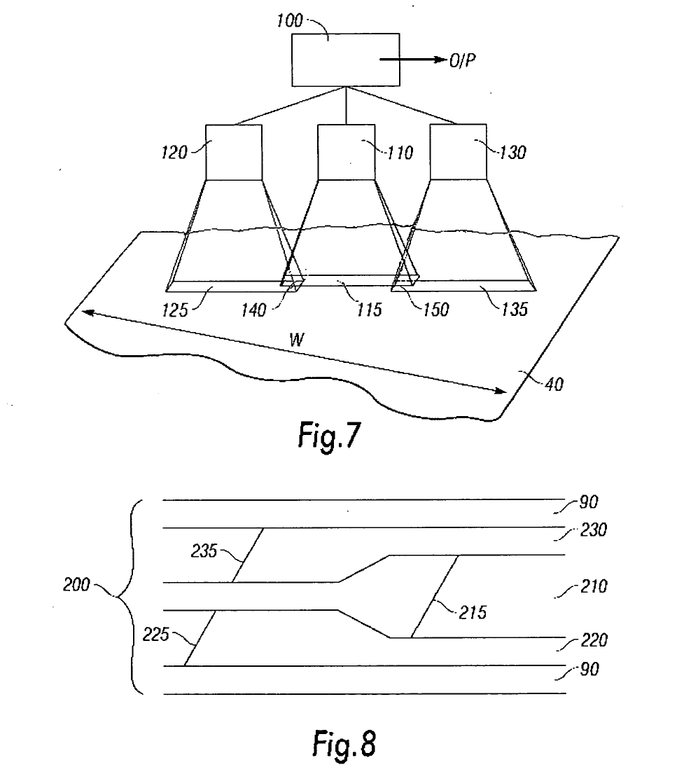

FIG. 7 is a schematic diagram of a magnetic tape reading system according to one embodiment of the present disclosure. The embodiment of FIG. 7 is similar to that of FIG. 4, with the exception that the pickup elements 110, 120 and 130 are positioned so that the paths 115′, 125′, 135′ followed by the respective read fields 115, 125, 135 include areas of overlap 140, 150.

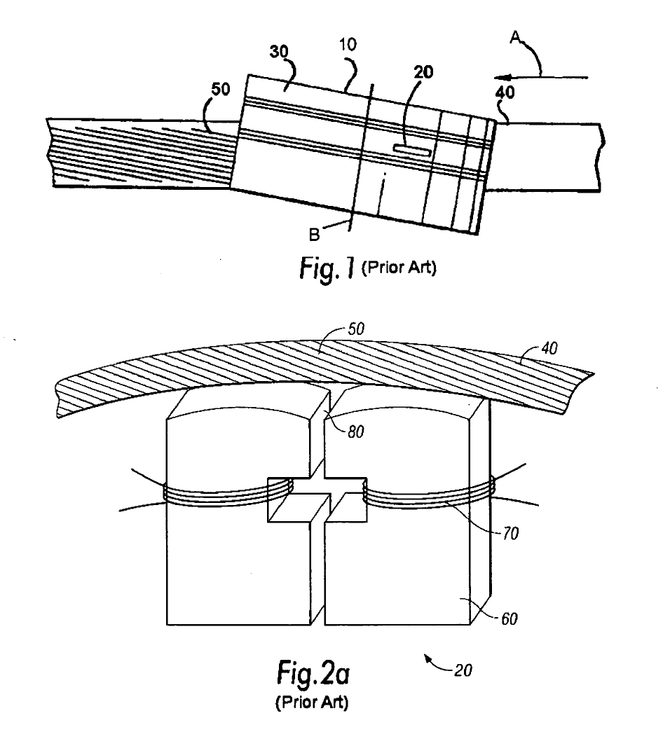

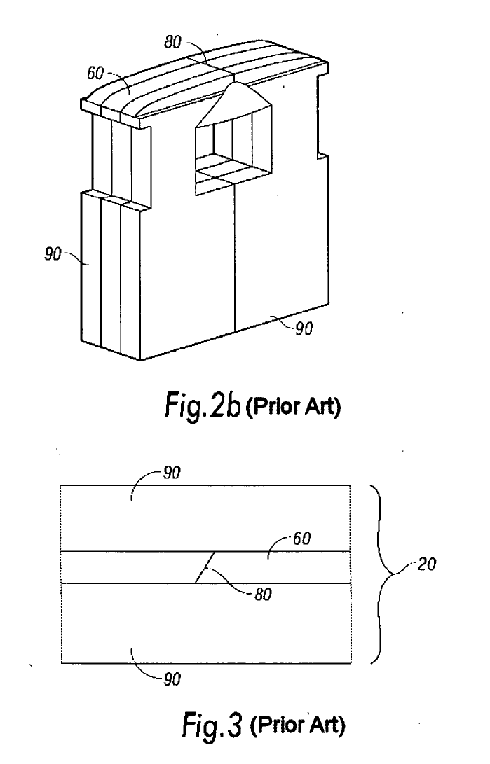

FIG. 8 is a view of a head element having multiple pickup elements for use in the embodiment of FIG. 7. The head element 200 includes a first electromagnet 210, a second electromagnet 220, and a third electromagnet 230 sandwiched between structural material 90. Each electromagnet includes a gap 215, 225, 235 so as to be receptive to magnetic fields from tracks on tapes in the same manner as the electromagnet of FIGS. 2 and 3. The gradual reduction in width of the first electromagnet 210 and corresponding increase in width of the second and third electromagnets 220, 230 is to create the areas of overlap 140, 150, of the paths shown in FIG. 7.

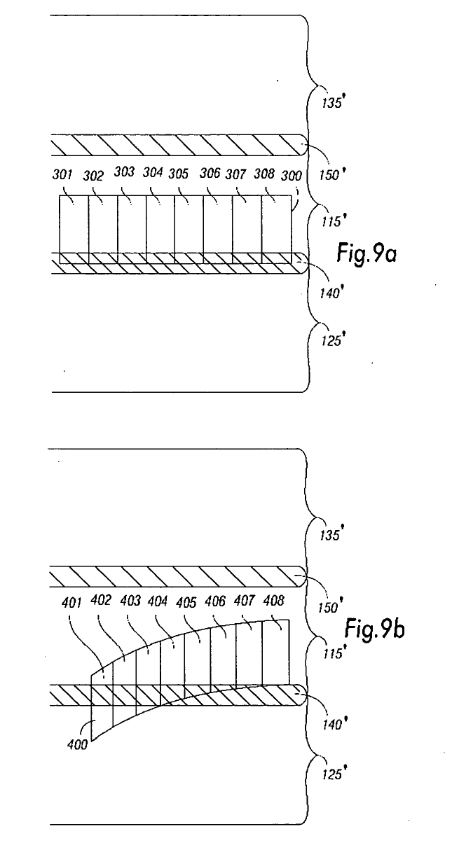

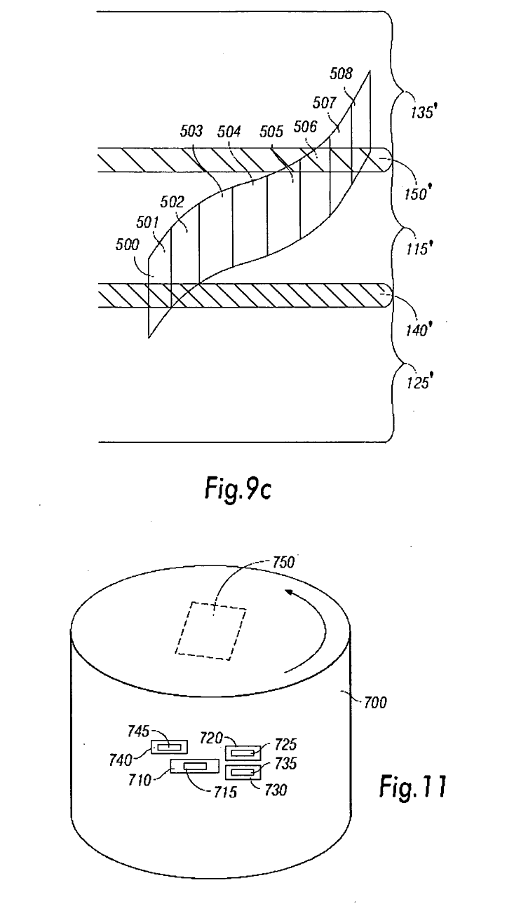

FIGS. 9a, 9b and 9c are schematic diagrams illustrating the embodiment of FIG. 7 in operation. The paths followed by read fields 115, 125, 135 are labeled 115′, 125′, and 135′ respectively, whilst the paths followed by the area of overlap 140 and 150 are labeled 140′ and 150′ respectively. As a track 300 on the magnetic tape passes through any of the respective read fields 115, 125, 135 of the pickup elements 110, 120, 130, an output signal is generated by the respective pickup element and presented to the controller 100. In the case of a non-distorted track that is substantially correctly aligned, as is shown in FIG. 9a, the surface area of the track carrying each data bit 301-308 passes through the read field 115 of the first pickup element 110, which generates a corresponding output signal. It will be noted that as an area of the track 300 passes through the overlap area 140, the data fields 301-308 would therefore also generate an output signal from the second pickup element 120, as they pass through the second read field 125. However, the proportion of the data fields 301-308 passing through the first read field 115 (as it follows its path 115′) is greater than that passing through the second read field 125 (as it follows its path 125′). In fact, all of the data bits 301-308 pass through the first read field. So, in dependence on the predetermined conditions, the controller 100 would choose the output signal from the first pickup element 110 as the output signal for each data bit 301-308.

In the case of a curved track 400, as is shown in FIG. 9b, the majority of the area of the track carrying the first two data bits 401, 402 falls within the second read field 125 as it follows its path 125′. Based on predetermined condition(s), the controller 100 would therefore select the output signal from the second pickup element 120 for these data bits. However, by the third data bit 403, the majority of the area of the track falls within the path 115 ′ followed by the first read field 115. The output signal from the first pickup element 110 would therefore be selected by the controller 100 in respect of the remaining data bits 403-408.

In the case of a significantly distorted track 500, such as that shown in FIG. 9c, at some point in time, the track 500 passes through paths 115′, 125′, 135′ followed by all three read fields 115, 125, 135. The controller 100 would select the output signal generated by one of the pickup elements 110, 120, 130 for each data bit 501-508 as the output signal, using the above mentioned predetermined conditions.

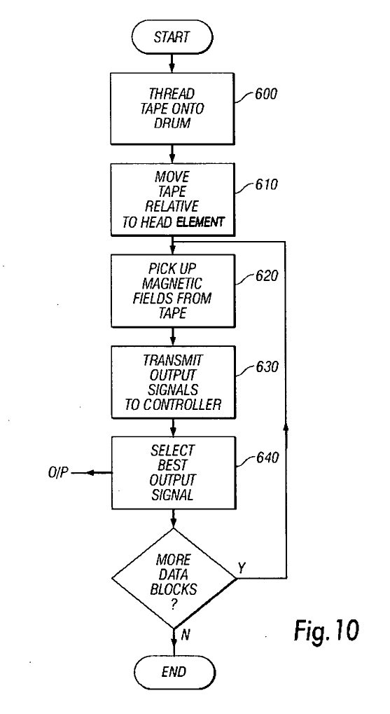

FIG. 10 is a flow diagram of the steps of a method according to an embodiment of the present disclosure. In step 600, a tape is threaded by a guide assembly so as to be presented to the helical scan drum of a tape drive. When it is desired to read from the tape, the drum is rotated and an appropriate control signal is sent to a drive mechanism, which starts to move the tape across the helical scan drum in step 610. In order to read the contents of a track from the tape, a number of pickup elements are operated in step 620 to detect magnetic fields falling within their respective read fields, which are aligned with the tape. The output signals for each pickup element are passed to a controller in step 630. For each data bit of a track, the controller selects the output signal from the pickup element having the best signal (e.g. highest magnitude) and outputs this in step 640. Steps 620 to 640 are repeated until there are no more data bits to be read.

Although the embodiments described above show multiple pickup elements within a single head element, it will be apparent to the skilled person that embodiments of the present disclosure could also be implemented having multiple head elements, as is shown in FIG. 11. In FIG. 11, a scan drum 700 includes a number of head elements 710, 720, 730, 740, each of which include a pickup element 715, 725, 735, 745. The head elements 710, 720, 730, 740 are positioned about the drum 700 such that as the drum is rotated, the read fields generated by the pickup elements 715, 725, 735, 745 are substantially adjacent and may overlap to a certain extent. A control system 750 is arranged to receive the output signals of the pickup elements 715, 725, 735, 745 and to select the best signal as the output from the scan drum. To keep implementation costs down, in such an embodiment it would be preferable that the head elements are in close proximity, although embodiments would be possible where head elements were spaced apart.

In some embodiments, neighboring tracks are each written to tape with a different azimuth so that if a tape is out of alignment sufficient for a neighboring track to fall within the read field of one of the pickup elements, it will not be detected. The pickup elements may be arranged to provide a time delay between one pickup element encountering a data bit of a track and an adjacent pickup element encountering it. In this manner, the controller could be given opportunity to process the output signal from the first pickup element before receiving that of the second pickup element.

The overlapping read fields may be generated at a single moment in time. Alternatively, the read fields may be spaced apart but be moved along paths that overlap over time. For example, a trailing pickup element may read a data bit later than a leading pickup element and as such does not have an overlapping read field at any given moment in time. However, the paths of the read fields could overlap, so if a snapshot of the read field of the leading element is taken followed by a snapshot of the adjacent element x microseconds later, the two snapshots would overlap. The head element of FIG. 8 would operate in such a manner.

It will be appreciated that the term “substantially adjacent” may refer to proximity at a point in time or to paths followed by read fields over time. In addition, the read fields do not need to be absolutely adjacent and gaps may exist between read fields without substantially affecting the operation of the above-described embodiments of the present disclosure.

Should it be found necessary, anti cross-talk measures could be implemented to prevent cross-talk between pickup elements. Such measures are known from existing multi channel head systems. The head elements discussed could be implemented in many ways. For example, head elements formed from electromagnets have been described and magneto-resistive head technology could also be used.

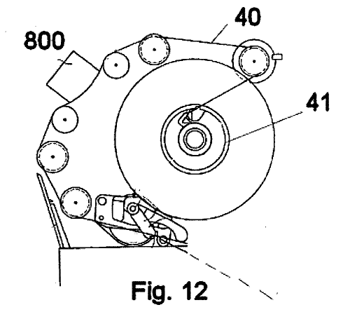

Although embodiments of the present disclosure have been discussed in relation to helical tape drives, it will be appreciated that the teachings of the present disclosure could also be applied to linear tape drives (such as DLT, SDLT, LTO, or similar formats) and disk drives. For example, FIG. 12 is a schematic diagram of elements of a digital linear tape drive for use to which an embodiment of the present disclosure can be applied. In digital linear tape drives, such as the one illustrated, magnetic tape 40 is guided from a tape reel 41 across a head 800. Instead of tracks being written at an angle to the tape travel direction, as in the above-described rotary tape drives, tracks in linear tape drives are parallel to the travel direction. Referring to FIG. 13, in a system according to a one embodiment of the present disclosure, the head 800 of a linear tape drive includes a plurality of pickup elements arranged in a similar manner to the arrangements discussed above.

In the case of use in a linear tape drive however, the tape 40 travels over the read fields (as opposed to both the tape and read fields moving as in previous embodiments). The pickup elements detect magnetic fields in their respective read fields 801-803 and output to a controller in the same manner as has been discussed above. Since the pickup elements, and therefore the read fields 801-803 do not move, the path followed by the read fields 801-803 is defined by the motion of the tape 40 over the head 800. It will be appreciated that in such an arrangement, a curved track or other positioning errors are dealt with in the same manner as the embodiments discussed above without the need to rewind or otherwise slow reading from the tape.

It should be emphasized that the above-described embodiments of the present disclosure are merely possible examples of implementations, merely set forth for a clear understanding of the principles of the present disclosure. Many variations and modifications may be made to the above-described embodiment(s) of the present disclosure without departing substantially from the spirit and principles of the present disclosure. All such modifications and variations are intended to be included herein within the scope of this disclosure and protected by the following claims.

1. A system for reading data recorded on a magnetic storage medium including a plurality of pickup elements and a controller, each said pickup element being arranged to have a respective read field for picking up a magnetic field from the magnetic storage medium, the read field being substantially adjacent to a read field of at least one other said pickup element, and to generate an output signal dependent on any magnetic field in its read field, the controller being arranged to select one of the output signals in dependence on at least one predetermined condition.

2. A system as claimed in claim 1, wherein the controller is arranged to monitor the output signals over time and switch to another output signal in dependence on the at least one predetermined condition.

3. A system as claimed in claim 1, wherein the at least one predetermined condition comprises selection of the output signal having the greatest signal amplitude, selection of the output signal having the highest signal-to-noise ratio, and a quality metric for assessing the quality of the output signals.

4. A system as claimed in claim 1, wherein each pickup element is arranged so that, over time, its respective read field follows a path that is substantially adjacent to that of a read field of at least one other pickup element.

5. A system as claimed in claim 1, wherein the pickup elements are arranged so that adjacent read fields include an area of overlap.

6. A system as claimed in claim 1, wherein the magnetic storage medium comprises magnetic tape.

7. A system as claimed in claim 1, further comprising a rotary scan head including at least one head element containing the plurality of pickup elements.

8. A system as claimed in claim 7, wherein the scan head comprises a plurality of head elements, each head element containing at least one pickup element for picking up signals from a magnetic recording tape.

9. A method of reading data recorded on a magnetic storage medium using a plurality of pickup elements each having a read field for picking up a magnetic field from the magnetic storage medium substantially adjacent to a read field of at least one other pickup element, the method comprising:
generating an output signal from each of a plurality of pickup elements in dependence on any magnetic field in its respective read field; and
selecting an output signal from those output signals of the pickup elements in dependence on at least one predetermined condition.

10. A method as claimed in claim 9, further comprising repeating the generating and selecting steps.

11. A method as claimed in claim 9, wherein the selecting step comprises:
selecting the output signal having the greatest signal amplitude;
selecting the output signal having the highest signal-to-noise ratio; and
assessing the quality of the output signals using a quality metric.

12. A system for reading data recorded on a magnetic storage medium, the system comprising:
a plurality of magnetic field reading means for detecting respective magnetic fields and generating an output signal in dependence on the respective detected magnetic field; and
control means for selecting one of said output signals in dependence at least one predetermined condition.

13. A system as claimed in claim 12, wherein each magnetic field reading means is arranged to detect a magnetic field within a predetermined area, the predetermined area of each magnetic field reading means being substantially adjacent to the predetermined area of another magnetic field reading means.

14. A system as claimed in claim 12, wherein the control means is operative to monitor the output signals over time and switch to another output signal in dependence on at least one predetermined condition.

15. A system as claimed in claim 12, wherein the predetermined condition comprises selection of the output signal having the greatest signal amplitude.

16. A system as claimed in claim 12, wherein the predetermined condition comprises selection of the output signal having the highest signal-to-noise ratio.

17. A system as claimed in claim 12, wherein the predetermined condition comprises a quality metric for assessing the quality of the output signals.

18. A system for reading data recorded on a magnetic storage medium comprising:
a plurality of pickup elements; and
a controller, wherein:
each pickup element is arranged to have a read field for picking up a magnetic field from the magnetic storage medium, the read field being substantially adjacent to a read field of at least one other pickup element; and
to generate an output signal dependent on any magnetic field in its read field, the controller is arranged to monitor the output signals over time and, for each of a number of predetermined points in time, to select one of said output signals in dependence on at least one predetermined condition selected from: output signal amplitude; signal-to-noise ratio; and an assessment based on a quality metric.

19. A rotary scan head including the system of claim 1.

20. A rotary scan head as claimed in claim 19, including at least one head element containing the plurality of pickup elements.

21. A rotary scan head as claimed in claim 19, including a plurality of head elements, each head element containing at least one pickup element.

22. A linear scan head including the system of claim 1.

23. A linear scan head as claimed in claim 22, including at least one head element containing the plurality of pickup elements.

24. A linear scan head as claimed in claim 23, including a plurality of head elements, each head element containing at least one pickup element.

25. A system for reading data recorded on a storage medium comprising:
a plurality of pickup elements; and
a controller, wherein:
each pickup element is arranged to have a read field for detecting one or more predetermined characteristics from an area of the storage medium, the read field being substantially adjacent to a read field of at least one other pickup element, and
to generate an output signal dependent on any predetermined characteristics in its read field, the controller is arranged to select an output signal from those of the pickup elements in dependence on at least one predetermined condition.
